(19) United States
(12) Patent Application Publication
(10) Pub. No.: US 2023/0192940 A1
(43) Pub. Date: Jun. 22, 2023

(54) GROUTING MATERIAL FOR REINFORCEMENT OF COAL-ROCK MASS IN LOW-TEMPERATURE MINING, AND PREPARATION METHOD AND USE THEREOF

(71) Applicants: Taiyuan University of Technology, Taiyuan (CN); Shanxi-Zheda Institute of Advanced Materials and Chemical Engineering, Taiyuan (CN)

(72) Inventors: Lan JIA, Taiyuan (CN); Yanlong MA, Taiyuan (CN); Jiahao SHEN, Taiyuan (CN); Nan YUAN, Taiyuan (CN); Hongwei HE, Taiyuan (CN)

(73) Assignees: Taiyuan University of Technology, Taiyuan (CN); Shanxi-Zheda Institute of Advanced Materials and Chemical Engineering, Taiyuan (CN)

(21) Appl. No.: 17/898,200

(22) Filed: Aug. 29, 2022

(30) Foreign Application Priority Data
Dec. 20, 2021 (CN) 202111559171.4

(51) Int. Cl. C08G 18/48; C08G 18/76; C08G 18/24; C08G 18/10; C08K 5/521; E02D 3/12

(52) U.S. Cl. CPC C08G 18/4829; C08G 18/7664; C08G 18/246; C08G 18/10; C08K 5/521; E02D 3/12

(57) ABSTRACT

The present disclosure relates to a grouting material for reinforcement of coal-rock mass in low-temperature mining. The material includes a component A and a component B, where the component A includes 100 parts of a polyether polyol A and 0.05 parts to 0.1 parts of a catalyst; the component B includes 18 parts to 24 parts of a polyether polyol B, 21 parts to 26 parts of a flame retardant, 50 parts to 61 parts of polyisocyanate, and 0.05 parts of the catalyst. A preparation method of the grouting material includes the following steps: stirring the polyether polyol A and the catalyst to obtain the component A; drying the polyether polyol B and mixing with the polyisocyanate and the catalyst, and conducting a reaction to obtain an isocyanate prepolymer; adding the flame retardant to the isocyanate prepolymer, and adjusting a viscosity to obtain the component B.

### CROSS REFERENCE TO RELATED APPLICATION

This patent application claims the benefit and priority of Chinese Patent Application No. 202111559171.4, filed on Dec. 20, 2021, the disclosure of which is incorporated by reference herein in its entirety as part of the present application.

### TECHNICAL FIELD

The present disclosure belongs to the field of reinforcement grouting materials, and in particular relates to a grouting material for reinforcement of coal-rock mass in low-temperature mining, and a preparation method and use thereof.

### BACKGROUND ART

Gas, coal dust, water, fire and roof disasters constitute the five major disasters in coal resource mining. For Shanxi, a large coal province, safety production is extremely important in coal mines. The extreme fragmentation of surrounding rock is a root cause of roof collapse accidents. The essence of fractured surrounding rock reinforcement is to fill the crack space of rock stratum, and enhance tensile and shear resistance between the crack structure surface and the grouting material, thereby finally improving an integrity and bearing capacity of the rock stratum.

Grouting is an effective method to control surrounding rock. Due to desirable flexibility, polyurethane grouting material can withstand deformation caused by the movement of underground rock formation, does not fall off and crack after curing, and has excellent adhesion, showing unique advantages. However, the polyurethane grouting material has reaction exotherm, high reaction temperature of the system, and inflammability, thus causing a certain safety hazard to the underground construction of coal mines. With the continuous innovation of coal mine safety standards, the latest safety production industry standard (AQ/T 1089-2020) requires that polymer materials for strengthening coal-rock mass in the coal mines have a maximum reaction temperature of not greater than 100° C. and a compressive strength of not less than 40 MPa.

At present, some polyurethane grouting materials have been disclosed for low-temperature mining. For example, patent No. 201210508997.2 disclosed a low-temperature and safe polyurethane grouting material for reinforcement of coal-rock mass and a preparation method thereof. In an example, a maximum reaction temperature was higher than 100° C. Patent No. 201310167698.1 disclosed a high-strength and low-exothermic flame-retardant grouting material for reinforcement in mining and a preparation method thereof. A maximum reaction temperature was less than 110° C. Patent No. 201911410951.5 disclosed an organic polymer-based and ultra-low-temperature reinforcement material for coal-rock mass. A maximum reaction temperature was 75° C. to 80° C., but there was no index related to mechanical properties. Therefore, under the new safety standard requirements, the original series of polyurethane grouting materials cannot be applied. There is an urgent need for new means to achieve the dual compliance of reaction temperature and compressive strength.

### SUMMARY

To solve the technical problems existing in the prior art, the present disclosure provides a grouting material for reinforcement of coal-rock mass in low-temperature mining. In the present disclosure, a part of reaction heat is released in advance by designing and preparing a prepolymer component, thereby reducing a maximum reaction temperature and maintaining a sufficient mechanical strength, to meet reinforcement requirements of coal-rock mass in coal mines.

The present disclosure further provides a preparation method of a grouting material for reinforcement of coal-rock mass in low-temperature mining.

The present disclosure further provides use of the grouting material for reinforcement of coal-rock mass in low-temperature mining.

To achieve the above objective, the present disclosure adopts the following technical solution:

I. The present disclosure provides a grouting material for reinforcement of coal-rock mass in low-temperature mining, including a component A and a component B in parts by weight as follows:

component A: 100 parts of a polyether polyol A, and
0.05 parts to 0.1 parts of a catalyst; and

component B: 18 parts to 24 parts of a polyether polyol B,
21 parts to 26 parts of a flame retardant,
50 parts to 61 parts of polyisocyanate, and
0.05 parts of the catalyst.

The polyether polyol A may be one or a combination of any two or three selected from the group consisting of sorbitol starting agent-typed polyether polyols YD-6205, YD-635, YD-600, YD-1050, and YD-380.

The catalyst may be one or a combination of more selected from the group consisting of dibutyltin dilaurate (DBTDL), stannous octoate, and quaternary ammonium salt-based catalysts TMR-2, TMR-3, and TMR-4.

The polyether polyol B may be PPG204, the polyisocyanate may be polyaryl polymethylene isocyanate (PAPI) (PM-200) from Wanhua Chemical Group Co., Ltd. (Shandong).

The flame retardant may be one or a combination of two selected from the group consisting of triethyl phosphate and cresyl diphenyl phosphate (CDP).

II. The present disclosure further provides a preparation method of the grouting material for reinforcement of coal-rock mass in low-temperature mining, including the following steps:

1) Preparation of the Component A:

stirring the polyether polyol A and the catalyst in a reaction kettle at room temperature for 1 h to obtain the component A; and

2) Preparation of the Component B:

drying the polyether polyol B in a vacuum drying box at a constant temperature of 110° C. for 2 h, cooling to 60° C., adding to the reaction kettle with the polyisocyanate and the catalyst in sequence, and conducting a reaction at 50° C. for 24 h to obtain an isocyanate prepolymer; cooling the isocyanate prepolymer to room temperature, adding the flame retardant, and adjusting a viscosity to 1,000 mPa·s±100 mPa·s to obtain the component B.

III. The present disclosure further provides use of the grouting material for reinforcement of coal-rock mass in low-temperature mining, including:

mixing the component A and the component B according to a mass ratio of 1:2 to 1:4 with a chemical grouting pump, injecting a mixture into a crack or cavity to be reinforced, and conducting curing.

Compared with the prior art, the present disclosure has the following beneficial effects:

I. In the present disclosure, a part of reaction heat is released by prepolymerization, such that a maximum reaction temperature is lowered to below 100° C., which reduces hidden dangers and safety accidents such as smoke and fire that may be due to a high reaction temperature during construction, thereby ensuring safe construction.

II. In the present disclosure, the sorbitol starting agent-typed polyether polyol is selected, with a large degree of cross-linking; and a consolidated body has a compressive strength of not less than 40 MPa and a certain toughness, which meets the safety standard requirements for coal-rock mass reinforcement.

III. In the present disclosure, a phosphorus-based flame retardant is used to meet the safety standard requirements, and can be widely used in coal mines.

### BRIEF DESCRIPTION OF THE DRAWINGS

FIG. 1 shows a schematic diagram of a temperature change curve of a sample in Example 1.

### DETAILED DESCRIPTION OF THE EMBODIMENTS

To make the to-be-resolved technical problems, the technical solutions, and the beneficial effects of the present disclosure clearer, the present disclosure is described in further detail below with reference to the accompanying drawings and embodiments. Understandably, the specific embodiments described herein are merely intended to explain the present invention but not to limit the present invention.

### Example 1

1. Preparation of a Component A

100 parts of a polyether polyol A (YD-6205, with functionality of 6 and a hydroxyl value of 380±15), 0.05 part of a catalyst dibutyltin dilaurate, and 0.05 part of a catalyst TMR-2 were added into a reaction kettle, and stirred for 1 h to obtain a mixed component A.

2. Preparation of a Component B

24 parts of a polyether polyol B (PPG-204) was dried in a vacuum drying oven at a constant temperature of 110° C. for 2 h, and cooled to room temperature, and added to a reaction kettle with 50 parts of polyisocyanate and 0.05 part of the catalyst dibutyltin dilaurate in sequence, and a reactor was conducted at 50° C. for 24 h to obtain an isocyanate prepolymer; the isocyanate prepolymer was cooled to room temperature, 26 parts of a flame retardant triethyl phosphate was added, and a viscosity was adjusted to 1,000 mPa·s±100 mPa·s to obtain the component B.

The components A and B were mixed by stirring according to a mass ratio of 2:5 to obtain a consolidated body, and product indicators were tested according to an AQ/T 1089-2020 standard. The test results were shown in Table 1.

TABLE 1
Product indicators

| SN | Item | Indicator |
|---|---|---|
| 1 | Maximum reaction temperature/° C. | 79 |
| 2 | Oxygen index | 29 |
| 3 | Expansion ratio/fold | 1 |
| 4 | Compressive strength (MPa) | 57.7 |
| 5 | Curing time | 6 min |
| 6 | Flame retardancy | Meeting AQ/T |
| | | 1089-2020 requirements |

The component A and the component B were mixed according to a mass ratio of 2:5 with a chemical grouting pump, a mixture was injected into a crack or cavity to be reinforced, and curing was conducted.

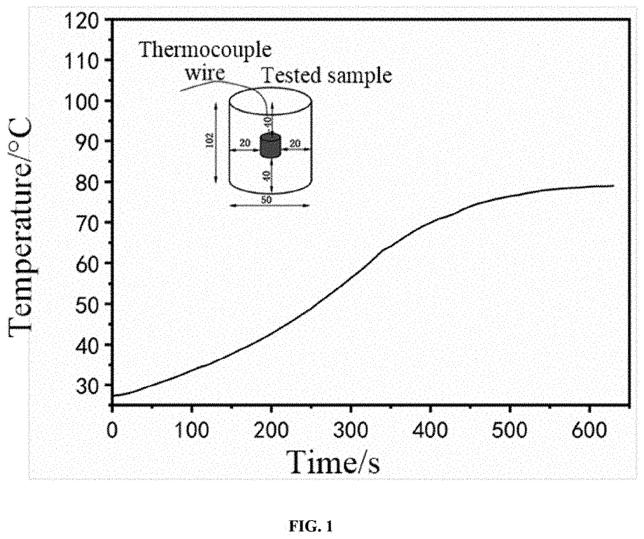

As shown in FIG. 1, as the reaction time increases, the maximum reaction temperature does not exceed 100° C., which meets the requirements of safety production industry standards.

### Example 2

1. Preparation of a Component A

100 parts of a polyether polyol A (YD-600, with functionality of 6 and a hydroxyl value of 455±15), 0.05 part of a catalyst dibutyltin dilaurate, and 0.05 part of a catalyst TMR-3 were added into a reaction kettle, and stirred for 1 h to obtain a mixed component A.

2. Preparation of a Component B

20 parts of a polyether polyol B (PPG-204) was dried in a vacuum drying oven at a constant temperature of 110° C. for 2 h, and cooled to room temperature, and added to a reaction kettle with 55 parts of polyisocyanate and 0.05 part of the catalyst dibutyltin dilaurate in sequence, and a reactor was conducted at 50° C. for 24 h to obtain an isocyanate prepolymer; the isocyanate prepolymer was cooled to room temperature, 25 parts of a flame retardant triethyl phosphate was added, and a viscosity was adjusted to 1,000 mPa·s±100 mPa·s to obtain the component B.

The components A and B were mixed by stirring according to a mass ratio of 1:4 to obtain a consolidated body, and product indicators were tested according to an AQ/T 1089-2020 standard.

The test results show that: a maximum reaction temperature is 79.4° C., a curing time is 5 min, a compressive strength is not less than 40 MPa, and an oxygen index and flame retardancy meet the requirements of AQ/T 1089-2020.

The component A and the component B were mixed according to a mass ratio of 1:4 with a chemical grouting pump, a mixture was injected into a crack or cavity to be reinforced, and curing was conducted.

### Example 3

1. Preparation of a Component A

100 parts of a polyether polyol A (YD-630, with functionality of 6 and a hydroxyl value of 490±15), 0.05 part of a catalyst dibutyltin dilaurate, and 0.05 part of a catalyst TMR-4 were added into a reaction kettle, and stirred for 1 h to obtain a mixed component A.

2. Preparation of a Component B

24 parts of a polyether polyol B (PPG-204) was dried in a vacuum drying oven at a constant temperature of 110° C. for 2 h, and cooled to room temperature, and added to a reaction kettle with 50 parts of polyisocyanate and 0.05 part of the catalyst dibutyltin dilaurate in sequence, and a reactor was conducted at 50° C. for 24 h to obtain an isocyanate prepolymer; the isocyanate prepolymer was cooled to room temperature, 26 parts of a flame retardant CDP was added, and a viscosity was adjusted to 1,000 mPa·s±100 mPa s to obtain the component B.

The components A and B were mixed by stirring according to a mass ratio of 1:3 to obtain a consolidated body, and product indicators were tested according to an AQ/T 1089-2020 standard. The test results show that: a maximum reaction temperature is 75.1° C., a curing time is 4 min, a compressive strength is not less than 40 MPa, and an oxygen index and flame retardancy meet the requirements of AQ/T 1089-2020.

The component A and the component B were mixed according to a mass ratio of 1:3 with a chemical grouting pump, a mixture was injected into a crack or cavity to be reinforced, and curing was conducted.

### Example 4

1. Preparation of a Component A

100 parts of a polyether polyol A (YD-6205, with functionality of 6 and a hydroxyl value of 380±15), and 0.1 part of a catalyst dibutyltin dilaurate, were added into a reaction kettle, and stirred for 1 h to obtain a mixed component A.

2. Preparation of a Component B

18 parts of a polyether polyol B (PPG-204) was dried in a vacuum drying oven at a constant temperature of 110° C. for 2 h, and cooled to room temperature, and added to a reaction kettle with 61 parts of polyisocyanate and 0.05 part of the catalyst dibutyltin dilaurate in sequence, and a reactor was conducted at 50° C. for 24 h to obtain an isocyanate prepolymer; the isocyanate prepolymer was cooled to room temperature, 21 parts of a flame retardant triethyl phosphate was added, and a viscosity was adjusted to 1,000 mPa·s±100 mPa·s to obtain the component B.

The components A and B were mixed by stirring according to a mass ratio of 1:2 to obtain a consolidated body, and product indicators were tested according to an AQ/T 1089-2020 standard. The test results show that: a maximum reaction temperature is 93° C., a curing time is 4 min, a compressive strength is not less than 40 MPa, and an oxygen index and flame retardancy meet the requirements of AQ/T 1089-2020.

### Example 5

1. Preparation of a Component A

100 parts of a polyether polyol A (YD-635, with functionality of 6 and a hydroxyl value of 490±15), 0.05 part of a catalyst dibutyltin dilaurate, and 0.05 part of stannous octoate, were added into a reaction kettle, and stirred for 1 h to obtain a mixed component A.

2. Preparation of a Component B

24 parts of a polyether polyol B (PPG-204) was dried in a vacuum drying oven at a constant temperature of 110° C. for 2 h, and cooled to room temperature, and added to a reaction kettle with 50 parts of polyisocyanate and 0.05 part of the catalyst dibutyltin dilaurate in sequence, and a reactor was conducted at 50° C. for 24 h to obtain an isocyanate prepolymer; the isocyanate prepolymer was cooled to room temperature, 16 parts of a flame retardant triethyl phosphate and 10 parts of a flame retardant CDP were added, and a viscosity was adjusted to 1,000 mPa·s±100 mPa·s to obtain the component B.

The components A and B were mixed by stirring according to a mass ratio of 1:3 to obtain a consolidated body, and product indicators were tested according to an AQ/T 1089-2020 standard. The test results show that: a maximum reaction temperature is less than 100° C., a compressive strength is not less than 40 MPa, and an oxygen index and flame retardancy meet the requirements of AQ/T 1089-2020.

The above described are merely preferred examples of the present disclosure, and are not intended to limit the present disclosure. Any modification, equivalent substitution, and improvement without departing from the spirit and principle of the present disclosure shall be included within the protection scope of the present disclosure.

What is claimed is:

1. A grouting material for reinforcement of coal-rock mass in low-temperature mining, comprising a component A and a component B in parts by weight as follows:
component A: 100 parts of a polyether polyol A, and
0.05 parts to 0.1 parts of a catalyst; and
component B: 18 parts to 24 parts of a polyether polyol B,
21 parts to 26 parts of a flame retardant,
50 parts to 61 parts of polyisocyanate, and
0.05 parts of the catalyst.

2. The grouting material for reinforcement of coal-rock mass in low-temperature mining according to claim 1, wherein the polyether polyol A is a sorbitol starting agent-typed polyether polyol.

3. The grouting material for reinforcement of coal-rock mass in low-temperature mining according to claim 1, wherein the catalyst is selected from the group consisting of dibutyltin dilaurate, stannous octoate, and a quaternary ammonium salt-based catalyst.

4. The grouting material for reinforcement of coal-rock mass in low-temperature mining according to claim 1, wherein the polyether polyol B is polyaryl polymethylene isocyanate (PAPI).

5. The grouting material for reinforcement of coal-rock mass in low-temperature mining according to claim 1, wherein the flame retardant is one or a combination of two selected from the group consisting of triethyl phosphate and cresyl diphenyl phosphate (CDP).

6. A preparation method of the grouting material for reinforcement of coal-rock mass in low-temperature mining according to claim 1, comprising the following steps:
1) preparation of the component A:
stirring the polyether polyol A and the catalyst in a reaction kettle at room temperature for 1 h to obtain the component A; and
2) preparation of the component B:
drying the polyether polyol B in a vacuum drying box at a constant temperature of 110° C. for 2 h, cooling to 60° C., adding to the reaction kettle with the polyisocyanate and the catalyst in sequence, and conducting a reaction at 50° C. for 24 h to obtain an isocyanate prepolymer; cooling the isocyanate prepolymer to room temperature, adding the flame retardant, and adjusting a viscosity to 1,000 mPa·s±100 mPa·s to obtain the component B.

7. Use of the grouting material for reinforcement of coal-rock mass in low-temperature mining according to claim 1, comprising: mixing the component A and the component B according to a mass ratio of 1:2 to 1:4 with a chemical grouting pump, injecting a resulting mixture into a crack or cavity to be reinforced, and conducting curing.
